(19) United States
(12) Patent Application Publication
(10) Pub. No.: US 2024/0301523 A1
(43) Pub. Date: Sep. 12, 2024

(54) ULTRA-DEEP INDUCTION HARDENING FOR TRACK PADS

(71) Applicant: Caterpillar Inc., Peoria, IL (US)

(72) Inventors: Scott Howard Magner, Dunlap, IL (US); Mircea Dumitru, Washington, IL (US); Brian Konrad Loeffler, Germantown Hills, IL (US); Mohammed Maniruzzaman, Edwards, IL (US); Yongqiang Li, Jiangsu (CN); Simon Jiang, Tianjin (CN)

(73) Assignee: Caterpillar Inc., Peoria, IL (US)

(21) Appl. No.: 18/119,885

(22) Filed: Mar. 10, 2023

(51) Int. Cl. C21D 1/10; C21D 1/18; C22C 38/04; C22C 38/44

(52) U.S. Cl. CPC C21D 1/10; C21D 1/18; C22C 38/04; C22C 38/44; C21D 2211/001

(57) ABSTRACT

Disclosed herein is an example track pad having a ground-contacting portion for use in a track-based machine to propel and support the machine across a supporting surface. The track pad may be a track pad that forms a link of a chain forming the track for the track-based machine. The track pad includes a cast body formed of a first alloy steel having a first strength and toughness. The track pad includes a roll path that contacts a roller of the track-based machine. The roll path is hardened through an induction hardening process to achieve a hardness level at a depth of 32 millimeters or more from the surface of the roll path. The roll path is shaped and positioned to contact rollers of the track drive assembly and thereby reduce wear and fatigue on the track pad as a result of contact and force transferred through the roller.

### TECHNICAL FIELD

The present disclosure relates to hardening processes for tracks for track-type machines. More specifically, the present disclosure relates to tracks having a roller path that is induction hardened to a depth more than twice a typical depth by using an ultra-deep induction hardening process.

### BACKGROUND

Track-type machines are in widespread use in construction, mining, forestry, and other similar industries. The undercarriage of such track-type machines utilizes track assemblies, rather than wheels, to provide ground-engaging propulsion. Such track assemblies may be preferred in environments where creating sufficient traction is problematic, such as those frequently found in the industries identified above. Specifically, rather than rolling across a work surface on wheels, track-type machines utilize one or more track assemblies that include an endless loop of coupled track links defining outer surfaces, which support ground-engaging track shoes, and inner surfaces that travel about one or more rotatable track-engaging elements, such as, drive sprockets, idlers, tensioners, and rollers, for example.

Typical track chain assembly designs include a track pin either fixedly or rotatably connected to a pair of chain links and a bushing rotatably positioned between the links and about the track pin. Such track chain assemblies can operate in extremely adverse environments in which track joints may be exposed to various abrasive mixtures of water, dirt, sand, rock or other mineral or chemical elements. For heavy equipment, such as electric rope shovels and like, track pads that incorporate the track rail and track shoe in a single, unitary body are used.

The track chain assembly may include a plurality of crawler shoes connected end-to-end via pins to form an endless loop. The endless loop of crawler shoes may be wrapped around corresponding drive wheels, one or more idler wheels, and at least one roller. Drive wheels may engage pins (or engage bushings that encase pins), drive lugs, or other features of crawler shoes and thereby transmit torque from engine to track assemblies. Idler wheels and rollers may guide track assemblies in a general elliptical trajectory around drive wheels. A tensioner may be located between idler wheel and drive wheel to push these components apart and thereby maintain a desired tension of track assembly. Crawler shoes may function to transmit the torque from drive wheels as a driving linear (tractive) force into a ground surface. The weight of machine may be transmitted from drive wheel, idler wheel, and rollers through crawler shoes as a bearing force into the ground surface.

For example, U.S. Pat. No. 10,669,602 (the “'602 patent”) describes a manufacturing process for a component subject to wear. The process includes depositing a clad layer having a thickness greater than 0.5 mm on a steel body of a component. The steel body is described as having a hardness between about 43 HRC and about 60 HRC using a hardfacing process. The hardfacing process includes heat treating the component for austenizing the component and quenching afterwards in a liquid bath. After heating, the component may be tempered after removing from the liquid bath. In an example, the '602 patent includes a track shoe for a track-type machine. However, due to the additional material (cladding) being added to the component, the processing time for a crawler shoe (e.g., track pad) is increased, as well as complexity and price. The interface between the drive wheel, idler wheel, and rollers described in the '602 patent can encounter high contact stresses which lead to galling failure of typical track pads.

Example embodiments of the present disclosure are directed toward overcoming the deficiencies described above.

### SUMMARY

In an example embodiment of the present disclosure, one general aspect includes a track system for track-based machinery. The track system includes an undercarriage supporting the track-based machinery. The system also includes a sprocket coupled to the undercarriage and driven by a motor and a roller coupled to the undercarriage. The system also includes a set of track pads forming an endless loop around the undercarriage, adjacent track pads coupled through bushings, a track pad of the set of track pads may include a body formed of an alloy steel having a first surface configured to contact a supporting surface and a second surface configured to contact the roller, where the body is produced by at least induction hardening at the second surface to a hardness of at least 50 HRC at a depth of 32 millimeters from the second surface.

Implementations may include one or more of the following features. The alloy steel may include a medium carbon steel alloy may include, by percent weight: carbon in a range of 0.30 percent to 0.40 percent, manganese in a range of 0.80 to 1.30 percent, nickel in a range of 1.00 to 1.70 percent, chromium in a range of 0.80 to 1.30 percent, and molybdenum in a range of 0.20 to 0.80 percent. A cross-sectional thickness of the track pad, from the first surface to the second surface, may be in a range of 250 millimeters to 400 millimeters. The body may be induction hardened a depth of at least ten percent of the cross-sectional thickness to a hardness in a range of 50 HRC to 60 HRC. The track pad may have a mass in a range of 1000 to 2000 kilograms. The induction hardening of the body may include setting a fixture distance between an induction coil and the second surface to a target distance, performing two or more pre-heat induction passes with the induction coil using a first set of parameters, performing an austenization pass using the induction coil using a second set of parameters, quenching the second surface using a polymer quench material, and tempering the body after quenching. The fixture distance may be in a range of 4 millimeters to 7 millimeters. The first set of parameters may include induction power in a range of 170 kilowatts to 200 kilowatts, induction frequency in a range of 300 hertz to 700 hertz, scanning speed in a range of 60 millimeters per minute to 90 millimeters per minute, and a maximum surface temperature of 1000 degrees Celsius. The second set of parameters may include induction power in a range of 170 kilowatts to 200 kilowatts, induction frequency in a range of 300 hertz to 700 hertz, scanning speed in a range of 55 millimeters per minute to 70 millimeters per minute, and a maximum surface temperature of 1000 degrees Celsius, a minimum temperature at a depth of 32 millimeters from the second surface of 820 degrees Celsius, and a flow rate for the polymer quench material in a range of 20 cubic meters per hour to 30 cubic meters per hour. The polymer quench material may include polymer at a concentration of at least 10 percent.

One general aspect includes a method for forming a track pad for track-based machinery. The method includes casting a body for the track pad using an alloy steel. The method also includes causing hardening of the body through a heat treatment and quench process. The method further includes causing an induction heat treatment of a roller path of the track pad by at least setting a fixture distance between an induction coil and the roller path to a target distance, performing two or more pre-heat induction passes with the induction coil using a first set of parameters, performing an austenization pass using the induction coil using a second set of parameters, quenching the roller path using a polymer quench material, and tempering the body after quenching.

One general aspect includes a track pad. The track pad includes a body formed of an alloy steel having a first surface configured to contact a supporting surface, and a second surface configured to contact a roller, where the body is produced by induction hardening at the second surface by at least: setting a fixture distance between an induction coil and the second surface to a target distance: performing two or more pre-heat induction passes with the induction coil using a first set of parameters: performing an austenization pass using the induction coil using a second set of parameters: quenching the second surface using a polymer quench material; and tempering the body after quenching.

### BRIEF DESCRIPTION OF DRAWINGS

FIG. 1 is a perspective of a track chain assembly for a track-type machine, implementing a track pad with ultra-deep hardening on the roll path, according to at least one example.

FIG. 2 is a perspective view of the track pad with ultra-deep hardening, according to at least one example.

FIG. 3 is a view of a process for hardening a roll path of the track pad, according to at least one example.

FIG. 4 illustrates a section view of a track pad with an induction component for induction heat treating a surface of the track pad, according to at least one example.

FIG. 5 is sectional illustration of the composite track pad contacting a roller of the track chain assembly, according to at least one example.

FIG. 6 is another sectional illustration of the track pad contacting the roller of the track chain assembly, according to at least one example.

FIG. 7 is a flow diagram depicting an example method for hardening the track pad described herein, according to at least one example.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. Various embodiments of the present disclosure include a track chain member, such as a track pad, and a track chain that may use a plurality of track chain members according to various embodiments of the present disclosure, etc.

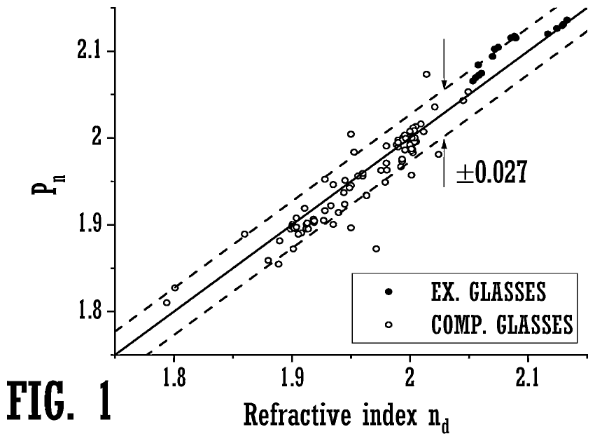

FIG. 1 is a perspective of a track chain assembly 100 for a track-type machine, implementing the composite track pad, according to at least one example. The track chain assembly 100 may be part of a track-type machine having an engine supported by a frame and configured to drive a tracked undercarriage. The track-type machine may be any machine that performs an operation associated with an industry such as mining, construction, farming, or another industry known in the art. For example, the track-type machine may be a material moving machine such as a front shovel, a rope shovel, a hydraulic excavator, a dozer, a loader, or another material moving machine.

The track chain assembly 100 includes an undercarriage frame 104 that supports a drive wheel 106, idler wheel 108, and rollers 110. The undercarriage frame 104 may include various components or elements for supporting different components of the track-type machine. The drive wheel 106 may be driven by an engine of the track-type machine to cause the track chain 102 to rotate around the undercarriage frame 104 to propel the track-type machine.

The track chain 102 is coupled with undercarriage frame 104 in a conventional manner. The track-type machine may include multiple track chains 102 for propelling the track-type machine. The track chain 102 includes a plurality of coupled together track pads 112 forming an endless loop extending about the drive wheel 106, idler wheel 108, and rollers 110, among other components. The rollers 110 are also mounted to the undercarriage frame 104 to support the track-type machine and guide track chain 102.

The unique design of track chain 102 and the overall track and undercarriage system of which they are a part are contemplated to enable the track-type machine to operate in certain environments such as soft underfoot conditions without becoming stuck. While use in the machine environment of an excavator or rope shovel is discussed herein, it should be understood that machine might comprise a different type of machine. For instance, track-type tractors or even half-track machines are contemplated herein. Further still, the machine might employ a conveyor or other type of machine wherein tracks are used for purposes other than as ground engaging elements. Also, the machine might be some type of hydraulic shovel, bulldozer, excavator, backhoe, etc.

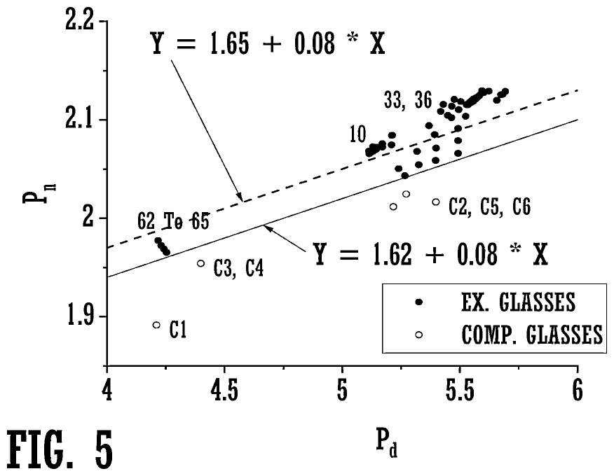

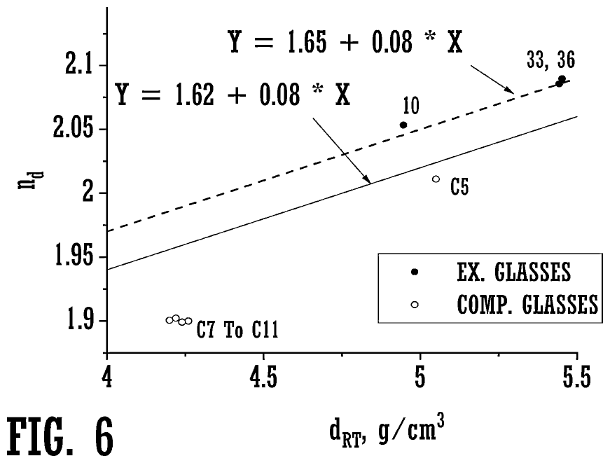

The track pads 112 include a cast body 114 formed of an alloy steel, such as a medium carbon steel forming the primary structural portion of the track pad 112. The cast body 114 includes contact surfaces for riding on a support surface and bushing contact surfaces for linking together the track pads 112 into the track chain 102. The cast body 114 also includes a roll path 116. The roll path 116 may contact the rollers of the undercarriage frame 104, such as shown and described with respect to FIGS. 5 and 6.

In some aspects, the track pads 112 may be sized such that particular forming processes are not available. For example, the dimensions of the track pad 112 may exceed 800 mm to 3600 mm in length by 300 mm to 600 mm in width by 250 mm to 400 mm in thickness thereby making forming through forge pressing unavailable due to size constraints of forge presses. In some examples, the track pad 112 may have a mass in a range of 1000 to 2000 kilograms that may also result in forming and/or hardening processes that may be used for smaller scale track pads to be unavailable for track pads of the size and dimensions described herein. Additionally, effective heat treatment and processing to a particular hardness and/or through annealing may be difficult due to the size of the track pads 112, which may retain a large amount of thermal heat during processing and therefore be difficult to quench and achieve hardness and toughness levels required for withstanding the forces experienced by the track pads 112 during use.

In typical track pads and conventional induction hardening processes, the hardness may not extend beyond around 17 millimeters. In the examples described herein, the hardening is enabled to reach an ultra-deep level, at a depth of around 32 millimeters. In conventional track pads, hardening to a limited depth, such as only up to 20 millimeters may result in abnormal or unexpected wearing. The depth may be in a range of 20 millimeters to 40 millimeters in some examples. In typical induction hardening systems, especially for track pads, the induction frequency is often in a range of around 1000 hertz to 4000 hertz with traditional processes. To achieve the desired depth of hardness, and thereby improve the lifespan and wear characteristics of the track pads, a frequency of around 300 hertz may be used for the induction process. In this manner, existing induction heating processes may be used, with different parameters and settings to achieve the hardness at the desired depths. Additionally, the use of the induction heating described herein on track pads having the size and mass characteristics described herein, may enable control of surface heating, and thereby reduce grain growth and control grain sizes in the material of the track pad.

In an example, the induction hardening may be performed at a frequency of 300 hertz to reach to depths indicated herein. Accordingly, for a track pad of a track-based machine, such as an electric rope shovel (ERS), the techniques and systems herein may enable hardening to a range of 50 Rockwell hardness C (HRC) to 60 HRC at a depth of 32 millimeters of more from the surface of the roll path 116.

Accordingly, the track pads 112 may be formed of a material having sufficient toughness for surviving a harsh environment, such as mining, while also being able to withstand the forces applied through the track pad assembly to support the weight of the track-type machine. For example, the cast body 114 may be formed of a hardenable steel having high toughness and shock resistance. In some examples, the cast body 114 may be formed of a medium-carbon alloy steel.

In some examples, the alloy steel may include a medium carbon steel alloy that includes, carbon in a range of 0.30 to 0.40 percent by weight, manganese in a range of 0.80 to 1.30 percent by weight, nickel in a range of 1.00 to 1.70 percent by weight, chromium in a range of 0.80 to 1.30 percent by weight, and molybdenum in a range of 0.20 to 0.80 percent by weight. In some examples, the alloy steel may include additional elements and/or components not listed herein.

In some aspects, at least part of the present disclosure relates to the formation, production, and/or manufacture of the track pad 112 and the components and systems in which the track pad is used, such as the track chain assembly 100 and/or track-type machine.

The formation of the track pad 112 may include casting of a body for the track pad 112 from an alloy steel. The body may be hardened through a traditional heat treatment and quench process. The body may be treated to improve hardness, toughness, and/or other characteristics of the track pad.

In order to harden the roll path 116 of the track pad 112, induction hardening of the roll path 116 may be used to improve the wear characteristics of the track pad 112. The induction hardening of the roll path 116 may include setting a fixture distance between an induction heating system (e.g., a coil). The fixture distance may be set such that a distance between the coil and the surface of the roll path 116 is in a range of 4 millimeters to 7 millimeters. The coil may be movable parallel to a surface of the roll path 116 while maintaining the fixture distance.

After the fixture distance is set, the process for hardening the roll path 116 further includes performing two or more pre-heat induction passes over the roll path 116 with the induction coil at the fixture distance. The pre-heat passes may be performed using a first set of parameters. For example, the pre-heat passes may include two to five passes of the induction coil. The pre-heat passes may be performed with the induction coil providing 170 kilowatts to 200 kilowatts of power to the roll path 116. Additionally, the first parameters may be performed with the frequency of the coil set within a range of 300 to 700 hertz. The coil may be moved over the roll path 116 at a scanning speed in a range of 60 millimeters per minute to 90 millimeters per minute. In this manner, the roll path may be pre-heated prior to hardening, with the pre-heating accomplishing heating at a depth from the roll path 116. The surface of the roll path 116 may be maintained, during the induction pre-heating at less than 1000 degrees Celsius.

After the pre-heat passes, an austenization pass and quench may be performed on the roll path 116 using the induction coil and a second set of parameters. The second set of parameters may include the induction coil providing 170 kilowatts to 200 kilowatts of power to the roll path 116. Additionally, the first second parameters may be performed with the frequency of the coil set within a range of 300 to 700 hertz. The coil may be moved over the roll path 116 at a scanning speed in a range of 55 millimeters per minute to 70 millimeters per minute. The surface of the roll path 116 may be maintained, during the austenization pass at less than 1000 degrees Celsius. Additionally, at a depth of at least 32 millimeters, the temperature may be at least 820 degrees Celsius. The quench after the austenization pass may include quenching the roll path 116 using a polymer quench material. The polymer quench material may include a polymer quench having a concentration of at least ten percent polymer within the quench material. The quench material may be delivered to the roll path 116 at a rate of 20 cubic meters per hour to 30 cubic meters per hour. In a particular example, the quench polymer may be delivered at a rate of 28 cubic meters per hour to the roll path 116.

After the austenization pass, the track pad 112 may be tempered, specifically after quenching. The tempering may occur at a temperature up to 180 degrees Celsius. The tempering may occur after a delay of 3 hours after quenching. Additionally, the tempering may occur for up to 240 minutes at the tempering temperature.

After treating the roll path 116, one or more additional surfaces may be treated in a manner similar to the manner described above for the roll path 116. For example, a ground-contacting surface may be treated to increase a hardness thereof, and provide a depth of hardness as described herein that may improve the lifespan of the track pad 112.

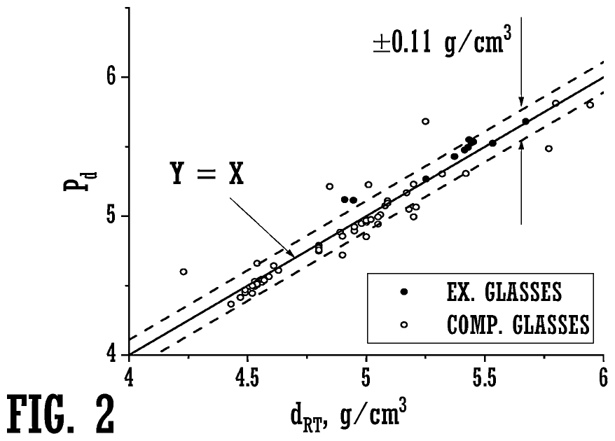

FIG. 2 is a perspective view of the composite track pad showing the roll path 116, according to at least one example. The track pad 112 of the present disclosure may be applicable to any track-type mobile machine. However, the disclosed track pads 112 may be particularly applicable to larger machines, in which the forces passing through the track assembly are significant and can affect longevity of the track pads 112. This may be particularly important for expensive machines that operate around the clock, where downtime and the price of replacement track pads are costly to the owner.

FIG. 2 shows a track pad 112 that may include one or more pairs of spaced-apart links 204 and 206 that are generally parallel with each other. Each link 204 and 206 may include at least one pin bore formed at an end thereof for connecting to links of other track pads 112, thereby forming a chain. Track pad 112 may include a ground-engaging surface 202. The ground-engaging surface 202 may be disposed at a bottom side of the cast body 114. In this example, the ground-engaging surface 202 and links 204 and 206 are integrally formed as a single cast and/or forged component. In other embodiments, links 204 and 206 and ground-engaging surface 202, as well as other components described herein may be formed separately and joined by any suitable process known in the art, such as by welding and/or using threaded fasteners, if desired. Ground-engaging surface 202 may have any external geometry known in the art. For example, ground-engaging surface 202 may be generally plate-like, include transverse ridges or grousers, have openings, and/or include any other features common in the art.

The cast body 114 includes a roll path 116 disposed on top side of insert 118. Roll path 116 may be disposed between links 204 and 206. The roll path 116 may define a surface for guiding a roller of the drive assembly across the track pad 112. The roll path 116 may include a wear surface that engages with the roller. The weight of the track-type machine may be transmitted from the roller through the roll path 116.

The roll path 116 may be planar, arcuate, or have any suitable shape for engaging the roller. For example, the roller may have a curvature, and the roll path 116 may be shaped with a similar curvature. When the machine is in motion, additional rolling and sliding forces between the roll path 116 and the roller create friction wearing of the roll path 116. Abrasive debris such as gravel, dirt, sand, or other ground material may lodge between the roller and the roll path 116 and cause additional wearing and/or grinding of roll path 116.

The roll path 116 may be hardened, as described herein. In order to harden the roll path 116 of the track pad 112, induction hardening of the roll path 116 may be used to improve the wear characteristics of the track pad 112. The induction hardening of the roll path 116 may include setting a fixture distance between an induction heating system (e.g., a coil). The fixture distance may be set such that a distance between the coil and the surface of the roll path 116 is in a range of 4 millimeters to 7 millimeters. The coil may be movable parallel to a surface of the roll path 116 while maintaining the fixture distance.

After the fixture distance is set, the process for hardening the roll path 116 further includes performing two or more pre-heat induction passes over the roll path 116 with the induction coil at the fixture distance. The pre-heat passes may be performed using a first set of parameters. For example, the pre-heat passes may include two to five passes of the induction coil. The pre-heat passes may be performed with the induction coil providing 170 kilowatts to 200 kilowatts of power to the roll path 116. Additionally, the first parameters may be performed with the frequency of the coil set within a range of 300 to 700 hertz. The coil may be moved over the roll path 116 at a scanning speed in a range of 60 millimeters per minute to 90 millimeters per minute. In this manner, the roll path may be pre-heated prior to hardening, with the pre-heating accomplishing heating at a depth from the roll path 116. The surface of the roll path 116 may be maintained, during the induction pre-heating at less than 1000 degrees Celsius.

After the pre-heat passes, an austenization pass and quench may be performed on the roll path 116 using the induction coil and a second set of parameters. The second set of parameters may include the induction coil providing 170 kilowatts to 200 kilowatts of power to the roll path 116. Additionally, the first second parameters may be performed with the frequency of the coil set within a range of 300 to 700 hertz. The coil may be moved over the roll path 116 at a scanning speed in a range of 55 millimeters per minute to 70 millimeters per minute. The surface of the roll path 116 may be maintained, during the austenization pass at less than 1000 degrees Celsius. Additionally, at a depth of at least 32 millimeters, the temperature may be at least 820 degrees Celsius. The quench after the austenization pass may include quenching the roll path 116 using a polymer quench material. The polymer quench material may include a polymer quench having a concentration of at least ten percent polymer within the quench material. The quench material may be delivered to the roll path 116 at a rate of 20 cubic meters per hour to 30 cubic meters per hour. In a particular example, the quench polymer may be delivered at a rate of 28 cubic meters per hour to the roll path 116.

After the austenization pass, the track pad 112 may be tempered, specifically after quenching. The tempering may occur at a temperature up to 180 degrees Celsius. The tempering may occur after a delay of 3 hours after quenching. Additionally, the tempering may occur for up to 240 minutes at the tempering temperature.

After treating the roll path 116, one or more additional surfaces may be treated in a manner similar to the manner described above for the roll path 116. For example, a ground-engaging surface 202 and/or drive lugs 120 may be treated to increase a hardness thereof, and provide a depth of hardness as described herein that may improve the lifespan of the track pad 112.

In the example of FIG. 2, track pad 112 includes a pair of drive lugs 120 disposed on the top side of the cast body 114 that engage drive wheels in the track assembly. Drive lugs 120 may be disposed between links 204 and 206 on either side of the roll path 116. In other embodiments, drive lugs 120 may be positioned at other locations on the track pad 112, and fewer or more drive lugs 120 may be included. Drive lugs 120 may contact openings, pockets, or teeth of drive wheels in the track assembly to receive torque from the engine and provide tractive force to the track pad 112 for moving the machine. Drive lugs 120 may have one or more wear surfaces that contact drive wheels. When the machine is in motion, these wear surfaces may experience grinding and wearing from the forces transmitted by drive wheels, which can be magnified when abrasive debris become lodged between drive lugs 120 and the drive wheels.

In some examples, the drive lugs 120 may be partially and/or entirely formed of a material that has high resistance to wear and abrasion., including high impact strength, tensile strength, and yield strength. In some aspects, a manganese-steel may be used for the drive lugs 120, such as an alloy of steel having 10% or more manganese contained therein. In some examples, the alloy may have between 12-14% manganese steel. In some aspects, ASTM A128 steel may be used for the drive lugs. The manganese-steel alloy for the drive lugs work-hardens rapidly upon being placed in use without an increase in brittleness, thereby providing greater wear and abrasion resistance against the sprockets of the track assembly than the cast body 114. In some examples, other work-hardening alloys and materials may be used to form the drive lugs, including stainless steels and other steel alloys with work-hardening properties similar to manganese-steel.

To withstand the bearing forces without cracking or breaking, the drive lugs may be formed of a metal having high strength, such as manganese steel. Manganese steel may be cast to produce the drive lugs 120 of any suitable shape and dimensions, but may be brittle after casting. Thus, the drive lugs 120 may be solution treated to achieve austenitic grain structure in the metal, which improves overall toughness. Before casting, chromium may be added to the manganese steel to promote faster work hardening of the austenitic manganese steel. Because austenitic manganese steel is also soft, drive lugs 120 may experience plastic deformation during use. Instead of performing expensive and time-consuming heat treatment processes to harden the cast body 114, work hardening of the drive lugs 120 may provide the required hardness to withstand the forces experienced during use. The drive lugs 120 and/or inserts of the drive lugs 120 may be formed and friction welded or otherwise joined to the cast body 114.

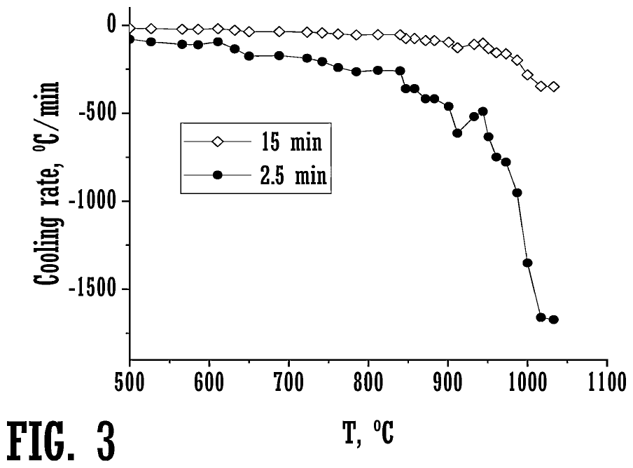

FIG. 3 is a view of a process 300 for hardening a roll path 314 of the track pad 304, according to at least one example. The track pad 304 may be similar and/or identical to the track pad 112 and the roll path 314 may be similar and/or identical to the roll path 116. In order to harden the roll path 314 of the track pad 304, induction hardening of the roll path 314 may be used to improve the wear characteristics of the track pad 304. The induction hardening of the roll path 314 may include setting a fixture distance between an induction heating system 306 and the roll path 314 at step 302. The fixture distance may be set such that a distance between the coil and the surface of the roll path 314 is in a range of 4 millimeters to 7 millimeters. The coil may be movable parallel (e.g., along direction 310) to a surface of the roll path 314 while maintaining the fixture distance.

After the fixture distance is set at step 302, the process 300 for hardening the roll path 314 further includes performing two or more pre-heat induction passes at step 308 over the roll path 314 with the induction coil at the fixture distance. The pre-heat passes may be performed using a first set of parameters. For example, the pre-heat passes may include two to five passes of the induction coil. The pre-heat passes may be performed with the induction coil providing 170 kilowatts to 200 kilowatts of power to the roll path 314. Additionally, the first parameters may be performed with the frequency of the coil set within a range of 300 to 700 hertz. The coil may be moved over the roll path 314 at a scanning speed in a range of 60 millimeters per minute to 90 millimeters per minute. In this manner, the roll path may be pre-heated prior to hardening, with the pre-heating accomplishing heating at a depth from the roll path 314. The surface of the roll path 314 may be maintained, during the induction pre-heating at less than 1000 degrees Celsius.

After the pre-heat passes, the process 300 may include, at step 312 an austenization pass and quench may be performed on the roll path 314 using the induction coil and a second set of parameters. The second set of parameters may include the induction coil providing 170 kilowatts to 200 kilowatts of power to the roll path 314. Additionally, the first second parameters may be performed with the frequency of the coil set within a range of 300 to 700 hertz. The coil may be moved over the roll path 314 at a scanning speed in a range of 55 millimeters per minute to 70 millimeters per minute. The surface of the roll path 314 may be maintained, during the austenization pass at less than 1000 degrees Celsius. Additionally, at a depth of at least 32 millimeters from the surface of the roll path 314, the temperature may be at least 820 degrees Celsius.

After the austenization pass, at step 316, the process 300 may include quenching with third parameters. The quench after the austenization pass may include quenching the roll path 314 using a polymer quench material 318. The polymer quench material 318 may include a polymer quench having a concentration of at least ten percent polymer within the quench material. The polymer quench material may be delivered to the roll path 314 at a rate of 20 cubic meters per hour to 30 cubic meters per hour. In a particular example, the quench polymer may be delivered at a rate of 28 cubic meters per hour to the roll path 314.

After the austenization pass, the track pad 304 may be tempered at step 320 using a heat source 322, specifically after quenching. The tempering may occur at a temperature up to 180 degrees Celsius. The tempering may occur after a delay of 3 hours after quenching. Additionally, the tempering may occur for up to 240 minutes at the tempering temperature.

After treating the roll path 314, one or more additional surfaces may be treated in a manner similar to the manner described above for the roll path 314. For example, a ground-contacting surface may be treated to increase a hardness thereof, and provide a depth of hardness as described herein that may improve the lifespan of the track pad 304.

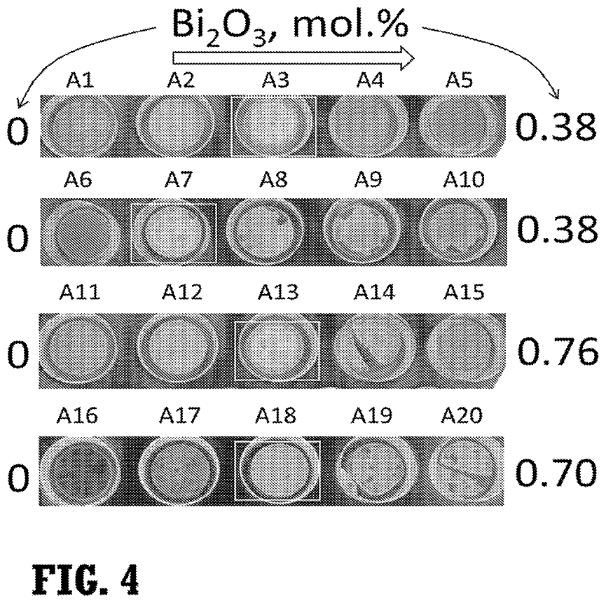

FIG. 4 illustrates a section view 400 of a track pad 402 with an induction component 404 for induction heat treating a surface 412 of the track pad 402, according to at least one example. During the induction heat treatment described herein, the induction component 404 is set at a fixture distance 406 in a range of 4 to 7 millimeters from the surface 412 of the track pad 402. The induction component 404 is maintained at the fixture distance 406 as the induction component 404 traverses parallel to the surface 412 of the track pad 402 (e.g., along direction 408).

The induction component 404 may be used, according to the process 300 to induction harden the surface region 410 of the track pad 402. The surface region 410 may extend a depth of 32 millimeters or more into the body of the track pad 402, the depth measured from the surface 412.

FIGS. 5 and 6 provide sectional illustrations of the track pad 112 having the roll path 116 with ultra-deep hardening contacting a roller 110 of the track chain assembly 100, according to at least one example. The roller 110 includes a roller surface 502 that contacts the roll path 116. The roller 110 is coupled to the undercarriage frame 104 that supports the weight of the track-type machine. Accordingly, the roller 110, and therefore the roller surface 502, transmits force to the roll path 116 and the track pad 112 to support the track-type machine.

The internal structure of the track pad 112, may have varying geometry, including passages, columns, holes, protrusions, and various other shapes and configurations. In some examples the composite track pad 112 has a solid body. In some examples, such as illustrated in FIG. 6, the track pad 112 may include various internal geometry. The track pad 112, and more specifically the cast body 114 is dimensioned and configured to provide structural support to the track pad 112 and thereby support the track-type machine.

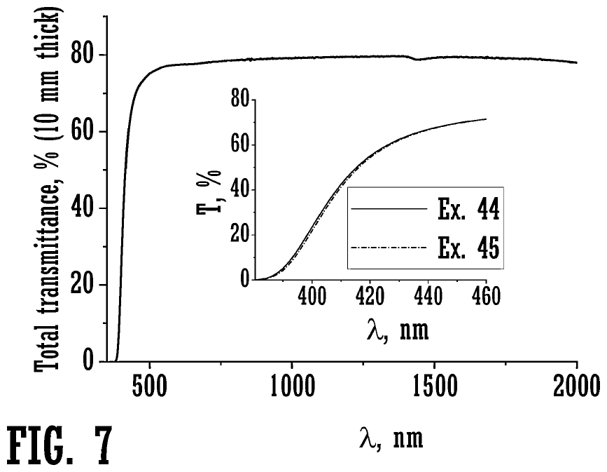

FIG. 7 is a flow diagram depicting an example method for hardening the track pad described herein, according to at least one example. The track pad 112 described herein may be applicable to any track-type mobile machine. However, the disclosed track pad may be particularly applicable to larger machines, in which the forces passing through the track assembly are significant and can affect longevity of the track pad. This may be particularly important for expensive machines that operate around the clock, where downtime and the price of replacement track pads are costly to the owner.

The process 700 may be performed to produce the track pads described herein for use in track-type machines. At 702, the process 700 includes casting a body using alloy steel. The alloy steel may have sufficient toughness for surviving a harsh environment, such as mining, while also being able to withstand the forces applied through the track pad assembly to support the weight of the track-type machine. For example, the cast body may be formed of a hardenable steel having high toughness and shock resistance. In some examples, the cast body may be formed of a medium-carbon alloy steel. For example, the cast body may include a medium carbon steel alloy that includes, carbon in a range of 0.30 to 0.40 percent by weight, manganese in a range of 0.80 to 1.30 percent by weight, nickel in a range of 1.00 to 1.70 percent by weight, chromium in a range of 0.80 to 1.30 percent by weight, and molybdenum in a range of 0.20 to 0.80 percent by weight. In some examples, the alloy steel may include additional elements and/or components not listed herein.

At 704, the process 700 includes uniformly hardening the cast body to a first hardness level. The hardness may be based on the operating environment and/or intended use for the track pad, but may include directly hardening the cast body.

At 706, the process 700 may include induction heat treatment, (e.g., induction hardening) of a roll path of the cast body. The induction heat treatment process may include sub-processes 708-714 for induction hardening of the roll path. In order to harden the roll path of the track pad a fixture distance may be set between an induction heating system and the roll path at step 708. The fixture distance may be set such that a distance between the coil and the surface of the roll path 314 is in a range of 4 millimeters to 7 millimeters. The coil may be movable parallel to a surface of the roll path while maintaining the fixture distance.

After the fixture distance is set at step 708, the process 700 further includes performing two or more pre-heat induction passes over the roll path with the induction coil at the fixture distance at step 710. The pre-heat passes may be performed using a first set of parameters. For example, the pre-heat passes may include two to five passes of the induction coil. The pre-heat passes may be performed with the induction coil providing 170 kilowatts to 200 kilowatts of power to the roll path. Additionally, the first parameters may be performed with the frequency of the coil set within a range of 300 to 700 hertz. The coil may be moved over the roll path at a scanning speed in a range of 60 millimeters per minute to 90 millimeters per minute. In this manner, the roll path may be pre-heated prior to hardening, with the pre-heating accomplishing heating at a depth from the roll path. The surface of the roll path may be maintained, during the induction pre-heating at less than 1000 degrees Celsius.

After the pre-heat passes, the process 700 may include, at step 712 an austenization pass and quench may be performed on the roll path using the induction coil and a second set of parameters. The second set of parameters may include the induction coil providing 170 kilowatts to 200 kilowatts of power to the roll path. Additionally, the first second parameters may be performed with the frequency of the coil set within a range of 300 to 700 hertz. The coil may be moved over the roll path at a scanning speed in a range of 55 millimeters per minute to 70 millimeters per minute. The surface of the roll path may be maintained, during the austenization pass at less than 1000 degrees Celsius. Additionally, at a depth of at least 32 millimeters from the surface of the roll path, the temperature may be at least 820 degrees Celsius.

After the austenization pass, at step 712, the process 700 may include quenching with third parameters. The quench after the austenization pass may include quenching the roll path using a polymer quench material. The polymer quench material may include a polymer quench having a concentration of at least ten percent polymer within the quench material. The polymer quench material may be delivered to the roll path at a rate of 20 cubic meters per hour to 30 cubic meters per hour. In a particular example, the quench polymer may be delivered at a rate of 28 cubic meters per hour to the roll path.

After the austenization pass, the track pad may be tempered at step 714 using a heat source, specifically after quenching. The tempering may occur at a temperature up to 180 degrees Celsius. The tempering may occur after a delay of 3 hours after quenching. Additionally, the tempering may occur for up to 240 minutes at the tempering temperature.

After treating the roll path, one or more additional surfaces may be treated in a manner similar to the manner described above for the roll path at step 716. For example, a ground-contacting surface may be treated to increase a hardness thereof, and provide a depth of hardness as described herein that may improve the lifespan of the track pad. Finally, additional machining and/or finishing may be performed on the track pad at 718 to prepare the track pad for assembly with the track-type machine.

It should be noted that some of the operations of process 700 may be performed out of the order presented, with additional elements, and/or without some elements. Some of the operations of process 700 may further take place substantially concurrently and, therefore, may conclude in an order different from the order of operations shown above.

### INDUSTRIAL APPLICABILITY

The present disclosure describes systems, structures, and methods to improve wear tolerance and toughness of components, such as components for track-type machines. These improved components may include track pads used in track chain assemblies of track-based machines. The track pads, as disclosed herein may have a roll path and/or wear surface having an ultra-deep hardening performed thereon for a contact surface of the track pad. The contact surface may be a surface that contacts a roller of the track drive assembly for the track-based machine. Although the track pads and the procedures to form the track pads are discussed in the context of track-type machines and undercarriages of those track-type machines, it should be appreciated that the track pads and the mechanisms to form the same are applicable across a wide array of mechanical systems, such as any mechanical system that can benefit from improved wear resistance of contact surfaces against friction and abrasion in regions of high force transfer.

As a result of the systems, apparatus, and methods described herein, consumable parts of machines, such as track pads may have a greater lifetime. For example, the track pads described herein may have greater service lifetime than traditional track pads that are not formed by the mechanisms described herein. In some cases, the track pads and/or other components may allow for a 25% to 400% improvement in the wear lifetime of consumable parts of track-type machines. This reduces field downtime, reduces the frequency of servicing and maintenance, and overall reduces the cost of heavy equipment, such as track-type machines. The improved reliability and reduced field-level downtime also improves the user experience such that the machine can be devoted to its intended purpose for longer times and for an overall greater percentage of its lifetime. Improved machine uptime and reduced scheduled maintenance may allow for more efficient deployment of resources (e.g., fewer, but more reliable machines at a construction site). Thus, the technologies disclosed herein improve the efficiency of project resources (e.g., construction resources, mining resources, etc.), provide greater uptime of project resources, and improves the financial performance of project resources.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A track system for track-based machinery, comprising
an undercarriage supporting the track-based machinery:
a sprocket coupled to the undercarriage and driven by a motor:
a roller coupled to the undercarriage; and
a set of track pads forming an endless loop around the undercarriage, adjacent track pads coupled through bushings, a track pad of the set of track pads comprising:
a body formed of an alloy steel having a first surface configured to contact a supporting surface and a second surface configured to contact the roller, wherein the body is produced by at least induction hardening at the second surface to a hardness of at least 50 HRC at a depth of 32 millimeters from the second surface.

2. The track system of claim 1, wherein the alloy steel comprises a medium carbon steel alloy comprising, by percent weight:
carbon in a range of 0.30 percent to 0.40 percent:
manganese in a range of 0.80 to 1.30 percent:
nickel in a range of 1.00 to 1.70 percent:
chromium in a range of 0.80 to 1.30 percent: and molybdenum in a range of 0.20 to 0.80 percent.

3. The track system of claim 1, wherein a cross-sectional thickness of the track pad, from the first surface to the second surface, is in a range of 250 millimeters to 400 millimeters.

4. The track system of claim 3, wherein the body is induction hardened a depth of at least ten percent of the cross-sectional thickness to a hardness in a range of 50 HRC to 60 HRC.

5. The track system of claim 1, wherein the track pad has a mass in a range of 1000 to 2000 kilograms.

6. The track system of claim 1, wherein the induction hardening of the body comprises:
setting a fixture distance between an induction coil and the second surface to a target distance:
performing two or more pre-heat induction passes with the induction coil using a first set of parameters:
performing an austenization pass using the induction coil using a second set of parameters:
quenching the second surface using a polymer quench material: and
tempering the body after quenching.

7. The track system of claim 6, wherein the fixture distance is in a range of 4 millimeters to 7 millimeters.

8. The track system of claim 6, wherein the first set of parameters comprise:
induction power in a range of 170 kilowatts to 200 kilowatts;
induction frequency in a range of 300 hertz to 700 hertz:
scanning speed in a range of 60 millimeters per minute to 90 millimeters per minute: and
a maximum surface temperature of 1000 degrees Celsius.

9. The track system of claim 6, wherein the second set of parameters comprise:
induction power in a range of 170 kilowatts to 200 kilowatts:
induction frequency in a range of 300 hertz to 700 hertz;
scanning speed in a range of 55 millimeters per minute to 70 millimeters per minute: and
a maximum surface temperature of 1000 degrees Celsius:
a minimum temperature at a depth of 32 millimeters from the second surface of 820 degrees Celsius; and
a flow rate for the polymer quench material in a range of 20 cubic meters per hour to 30 cubic meters per hour.

10. The track system of claim 6, wherein the polymer quench material comprises polymer at a concentration of at least 10 percent.

11. A method for forming a track pad for track-based machinery, comprising:
casting a body for the track pad using an alloy steel:
causing hardening of the body through a heat treatment and quench process: and
causing an induction heat treatment of a roller path of the track pad by at least:
setting a fixture distance between an induction coil and the roller path to a target distance:
performing two or more pre-heat induction passes with the induction coil using a first set of parameters:
performing an austenization pass using the induction coil using a second set of parameters:
quenching the roller path using a polymer quench material; and
tempering the body after quenching.

12. The method of claim 11, wherein the first set of parameters comprise:
induction power in a range of 170 kilowatts to 200 kilowatts:
induction frequency in a range of 300 hertz to 700 hertz;
scanning speed in a range of 60 millimeters per minute to 90 millimeters per minute: and
a maximum surface temperature of 1000 degrees Celsius.

13. The method of claim 11, wherein the second set of parameters comprise:
induction power in a range of 170 kilowatts to 200 kilowatts:
induction frequency in a range of 300 hertz to 700 hertz:
scanning speed in a range of 55 millimeters per minute to 70 millimeters per minute: and
a maximum surface temperature of 1000 degrees Celsius:
a minimum temperature at a depth of 32 millimeters from the roller path of 820 degrees Celsius; and
a flow rate for the polymer quench material in a range of 20 cubic meters per hour to 30 cubic meters per hour.

14. The method of claim 11, wherein the fixture distance is in a range of 4 millimeters to 7 millimeters.

15. The method of claim 11, wherein the polymer quench material comprises polymer at a concentration of at least 10 percent.

16. The method of claim 11, wherein the two or more-pre-heat induction passes comprise four pre-heat induction passes.

17. The method of claim 11, wherein the track pad has a mass in a range of 1000 to 2000 kilograms.

18. The method of claim 11, further comprising causing an induction heat treatment of second surface of the track pad by at least:
setting a fixture distance between an induction coil and the second surface to a second target distance:
performing two or more pre-heat induction passes with the induction coil using a third set of parameters:
performing an austenization pass on the second surface using the induction coil using a fourth set of parameters:
quenching the roller path using a polymer quench material; and
tempering the body after quenching.

19. A track pad, comprising:
a body formed of an alloy steel having:
a first surface configured to contact a supporting surface, and
a second surface configured to contact a roller, wherein the body is produced by induction hardening at the second surface by at least:
setting a fixture distance between an induction coil and the second surface to a target distance:
performing two or more pre-heat induction passes with the induction coil using a first set of parameters:
performing an austenization pass using the induction coil using a second set of parameters:
quenching the second surface using a polymer quench material: and
tempering the body after quenching.

20. The track pad of claim 19, wherein:
the track pad has a mass in a range of 1000 to 2000 kilograms; and
the alloy steel comprises a medium carbon steel alloy comprising, by percent weight:
carbon in a range of 0.30 percent to 0.40 percent:
manganese in a range of 0.80 to 1.30 percent:
nickel in a range of 1.00 to 1.70 percent:
chromium in a range of 0.80 to 1.30 percent: and
molybdenum in a range of 0.20 to 0.80 percent.
